(19) United States
(12) Patent Application Publication
(10) Pub. No.: US 2004/0207263 A1
(43) Pub. Date: Oct. 21, 2004

(54) Power line communication device for vehicle

(76) Inventors: Yo Yanagida, Shizuoka-ken (JP); Terumitsu Sugimoto, Shizuoka-ken (JP)

Correspondence Address: Finnegan, Henderson, Farabow,, Garrett & Dunner, L.L.P., 1300 I Street, N.W., Washington, DC, 20005-3315, US

(21) Appl. No.: 10/652,205

(22) Filed: Sep. 2, 2003

(30) Foreign Application Priority Data
Sep. 3, 2002 (JP) P2002-257573

(51) Int. Cl. H02G 3/00

(52) U.S. Cl. 307/10.1

(57) ABSTRACT

A power line communication device for vehicle includes a voltage follower (4), which is configured to receive a reception communication signal with an input terminal, to generate a standard level for comparison which follows direct-current voltage fluctuation at the input terminal, and to output the standard level for comparison and the communication signal. The power line communication device for vehicle includes a comparator unit (5), which is configured to compare the standard level for comparison outputted from the voltage follower (4) with the reception communication signal, and to amplify the communication signal which is superimposed and modulated on direct-current power on a power line (11).

### BACKGROUND OF THE INVENTION

This invention relates to a power line communication device for vehicle which is configured to superimpose various signals used in a vehicle on a power line for communication.

Performance of automobiles continues to advance in recent years and an automobile today is equipped with many electronic control units (ECUs). The ECUs are provided not only to control an engine and a transmission, but also to control power windows, lamps, side mirrors, and the like. The respective ECUs operate in relation to one another. Accordingly, the respective ECUs are mutually connected through exclusive signal lines provided among the ECUs or through a common bus to the ECUs. Signals are inputted to and outputted from the ECUs through the signal lines or through communication lines in the bus.

Recently, the number of ECUs equipped in an automobile is increased, or the number of signals is increased due to more intricate control. Accordingly, the number of communication lines connecting among the ECUs tends to be increased as well. Such a tendency raises a problem of an increase in size and cost of a wire harness including the communication lines.

To solve this problem, a technique for reducing the number of communication lines has been developed (see Japanese Patent Application Publication Laid-open Hei. 10-174282, for example). Specifically, signals inputted to and outputted from the ECUs are superimposed on a power line for supplying electricity to the ECUs to perform communication among the ECUs. A power line communication device for vehicle (hereinafter referred to as “PLC”) which superimposes the signals on the power line and performs communication among the ECUs is connected to the power line.

### SUMMARY OF THE INVENTION

Incidentally, to enable reception and transmission of a communication signal efficiently, the PLC included in the ECU is required to shorten a time interval for initiating transmission after reception or a time interval for initiating reception after transmission.

To realize the aforementioned purpose, a signal outputted from an output part needs to be a zero-cross signal. However, the use of a zero-cross communication signal has raised a problem of an increase in size and complexity of a configuration of a transmitter, and a cost increase.

Meanwhile, when low-frequency noises such as noises attributable to engine revolution or noises attributable to driving the ECU are superimposed on the power line, these noises which a bandpass filter fails to remove is inputted to a comparator unit. Accordingly, the comparator unit bears a risk of malfunction which causes a trouble to amplify a reception signal properly and to disable the demodulation.

An object of the present invention is to provide a power line communication device for vehicle which can enhance communication efficiency and prevent malfunction of a comparator unit.

In a first aspect of the invention, a power line communication device for vehicle includes a voltage follower configured to receive a reception communication signal with an input terminal, to generate a standard level for comparison which follows direct-current voltage fluctuation at the input terminal, and to output the standard level for comparison and the communication signal. This communication device also includes a comparator unit configured to receive the standard level for comparison and the communication signal, to compare the standard level for comparison with the communication signal, and to amplify the communication signal which is superimposed and modulated on direct-current power on a power line.

This communication device is included in an electronic control unit controlling respective functions of a vehicle, and the communication device is connected to the power line to supply the direct-current power to the vehicle and configured to receive the communication signal superimposed on the direct-current on the power line, to separate and extract the communication signal superimposed on a direct-current component, to superimpose and transmit the generated communication signal on the direct-current power on the power line, and to execute the transmission and reception of the communication signal between the electronic control units.

According to the characteristics described above, it is possible to generate the standard level for comparison which follows the voltage fluctuation at the input terminal of the voltage follower. In this way, even when the voltage at the input terminal fluctuates after transmission of the communication signal, it is possible to securely amplify and demodulate the reception communication signal by comparing the communication signal with the standard level for comparison. Therefore, the communication device can receive a subsequent communication signal immediately after transmission of the communication signal and drastically shorten a time interval for reception after transmission as compared with the related art, and thereby improve communication efficiency.

Even when a low-frequency noise is included in the reception communication signal, the standard level for comparison is generated which follows the voltage fluctuation at the input terminal of the comparator unit. In this way, the reception communication signal is accurately compared with the standard level for comparison and a risk of malfunction is thereby eliminated. Therefore, even if the low-frequency noise is included in the reception signal, it is possible to securely demodulate the reception signal.

Preferably, the comparator unit includes a comparator having a first input terminal and a second input terminal. The voltage follower includes voltage-dividing resistors connected in series between a high-voltage power source and a low-voltage power source. The voltage follower includes a capacitor configured to remove a given frequency component from the reception communication signal and to obtain a direct-current component of the communication signal. A first junction of the voltage-dividing resistors is connected to the first input terminal. A second junction of the voltage-dividing resistors is connected to the second input terminal. The capacitor is connected between the first input terminal and the low-voltage power source.

Preferably, the comparator unit includes a comparator having a first input terminal and a second input terminal. The voltage follower includes voltage-dividing resistors connected in series between a high-voltage power source and a low-voltage power source. The voltage follower includes a filter configured to remove a given frequency component from the reception communication signal and to obtain a direct-current component of the communication signal. A first junction of the voltage-dividing resistors is connected to the first input terminal. A second junction of the voltage-dividing resistors is connected to the second input terminal. The filter is connected to the first input terminal.

### BRIEF DESCRIPTION OF THE ACCOMPANYING DRAWINGS

FIG. 1 is a view showing a configuration of an ECU including a power line communication device for vehicle (PLC) according to one embodiment of this invention;

FIG. 2 is a view showing configurations of a voltage follower and a comparator unit;

FIGS. 3A to 3D are views showing waveforms of reception and transmission signals when an engine is stopped and waveforms of signals inputted to and outputted from comparator 51;

FIG. 3A is a voltage waveform of a transmission signal when the engine is stopped;

FIG. 3B is a voltage waveform of a reception signal when the engine is stopped;

FIG. 3C is a signal waveform to be inputted to the comparator;

FIG. 3D is a signal waveform to be outputted from (demodulated by) the comparator;

FIGS. 4A to 4D are views showing waveforms of reception and transmission signals when the engine is driven and waveforms of signals inputted to and outputted from comparator 51;

FIG. 4A is a voltage waveform of a transmission signal when the engine is driven;

FIG. 4B is a voltage waveform of a reception signal when the engine is driven;

FIG. 4C is a signal waveform to be inputted to the comparator; and

FIG. 4D is a signal waveform to be outputted from (demodulated by) the comparator.

### DETAILED DESCRIPTION OF THE PREFERRED EMBODIMENTS

Hereinafter, an embodiment of this invention will be described with reference to the accompanying drawings.

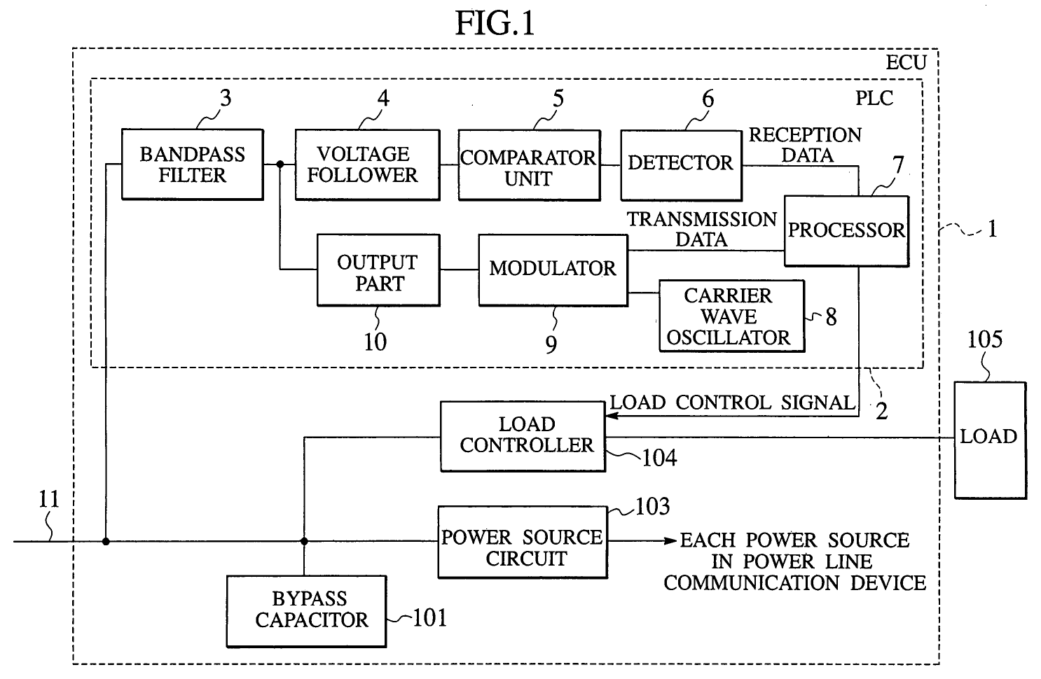

In FIG. 1, an ECU 1 includes a bypass capacitor 101 connected to a power line 11 and configured to suppress voltage fluctuation. A power supply voltage for a vehicle such as a 12-V power supply voltage is supplied to a power source circuit 103 through power line 11. The 12-V power supply voltage is converted into an operating power supply voltage for electronic devices inside the vehicle at 5 V, for example, by power source circuit 103 comprising a regulator, and is supplied to the electronic devices inside the vehicle.

A load controller 104 comprises switching elements such as relays. Load controller 104 is switch-controlled based on a load control signal, and thereby controls a load drive current which is provided through power line 102. A load 105 is a drive motor for a power window or a side mirror, or a lamp, for example. Load 105 is driven by a drive current provided from power line 11 through load controller 104. Power line communication device for vehicle (hereinafter referred to as “PLC”) 106 is connected to power line 102. PLC 106 superimposes signals on power line 102 and performs communication among the ECUs.

In PLC 2, when ECU 1 receives a communication signal, a communication signal superimposed on power line 11 and thereby modulated is provided to a comparator unit 5 through a bandpass filter 3. The communication signal is compared and amplified by comparator unit 5 using a standard level for comparison generated by a voltage follower 4. The amplified communication signal is detected by a detector 6 as reception data. The reception data are provided to a processor 7 for executing various processes. The load control signal is generated by processor 7 as one of the processes and is provided to load controller 104.

Meanwhile, when ECU 1 transmits the communication signal, transmission data are generated by processor 7 and provided to a modulator 9. The transmission data provided to modulator 9 are modulated together with a carrier wave oscillated by a carrier wave oscillator 8. The modulated transmission data are provided to power line 11 through an output part 10 and are superimposed on direct-current power on the power line 11 and then transmitted.

In FIG. 1, PLC 2 incorporated in ECU 1 includes bandpass filter 3, voltage follower 4, comparator unit 5, detector 6, processor 7, carrier waver oscillator 8, modulator 9, and output part 10.

In FIG. 1, a signal which is superimposed on the direct-current power in the power line 11 supplying the direct-current power to the vehicle and communicated between the ECUs is inputted to bandpass filter 3. Bandpass filter 3 removes low-frequency and high-frequency noise components from the communication signal. The communication signal after removing the noise components is provided to voltage follower 4. A digital signal communicated between the ECUs is subjected to ASK modulation to a higher frequency and is transmitted to power line 11 as described later.

Voltage follower 4 generates a standard level for comparison which follows the voltage fluctuation at a junction N1 where bandpass filter 3, voltage follower 4, and output part 10 are connected. In other words, voltage follower does not generate a fixed standard level for comparison but generates the standard level for comparison which varies in response to the voltage fluctuation at junction N1. The standard level for comparison thus generated and the reception signal outputted from bandpass filter 3 to voltage follower 4 are provided to comparator unit 5.

The reception signal and the standard level for comparison provided from voltage follower 4 are inputted to comparator unit 5. Comparator unit 5 amplifies the reception signal by comparing the modulated reception signal with the standard level for comparison. The reception signal thus amplified is provided to detector 6.

The reception signal provided from comparator unit 5 is inputted to detector 6. Detector 6 detects the reception signal amplified by comparator unit 5, and extracts the communication signal superimposed on power line 11 as reception data. The reception data are provided to processor 7.

Processor 7 includes a computer such as a CPU or the like and performs various processes based on the reception data. Processor 7 generates a load control signal for controlling load controller 104 in one of the various processes executed based on the reception data. The load control signal is provided to load controller 104. Load controller 104 is controlled as described above based on this load control signal. Processor 7 generates transmission data to be transmitted to other ECUs. The transmission data are provided to modulator 9.

Carrier wave oscillator 8 oscillates a carrier wave for superimposing and transmitting the transmission data on power line 11. This carrier wave is provided to modulator 9.

The transmission data generated by processor 7 and the carrier wave oscillated by carrier wave oscillator 8 are inputted to modulator 9. Modulator 9 subjects the transmission data to ASK (amplitude shift keying) modulation. The modulated transmission data are provided to output part 10.

In the multiplex communication realized by superimposing the communication signal (a baseband) on the power line 11, if the carrier wave has a low frequency in a range from several hundred Hz to several kHz, for example, the communication signal is significantly attenuated by a bypass capacitor mounted on an electronic device connected to the power source. Therefore, attenuation of the communication signal attributable to the bypass capacitor is suppressed by subjecting the communication signal to the ASK modulation at a high frequency of several megahertz (2.5 MHz, for example), and the power source superimposing multiplex communication can be performed stably. The ASK modulation can be realized by a simple constitution and at a low cost compared with other modulation methods.

The transmission data provided from modulator 9 are inputted to output part 10. Output part 10 amplifies the ASK-modulated transmission data and outputs the data to power line 11 through bandpass filter 3.

When ECU 1 receives the communication signal, the communication signal superimposed on power line 11 is provided to comparator unit 5 through bandpass filter 3 and voltage follower 4. The ASK-modulated communication signal is compared and amplified by comparator unit 5 relevant to the standard level for comparison generated by voltage follower 4. The amplified communication signal is detected by detector 6 as the reception data. The reception data are provided to processor 7 and subjected to various processes.

Meanwhile, when ECU 1 transmits the communication signal, the transmission data generated by processor 7 are provided to modulator 9. The transmission data provided to modulator 9 are subjected to the ASK modulation which generates a high-frequency signal in a bandwidth of several MHz together with the carrier wave oscillated by carrier wave oscillator 8. The modulated transmission data are provided to power line 11 through output part 10 and are superimposed on the direct-current power on the power line 11 and then transmitted.

The power supply voltage provided to power line 11, such as a 12-V direct-current voltage, is supplied to power source circuit 103. The 12-V power supply voltage is converted into 5 V, for example, by power source circuit 103 as an operating power supply voltage for electronic devices inside the vehicle. The power supply voltage converted into 5 V is supplied to the electronic devices as the power supply. The power supply voltage provided to power line 11 is supplied to load controller 104. The power supply voltage provided to load controller 104 is supplied to load 105 through load controller 104 when driving load 105, and load 105 is driven by the supplied voltage.

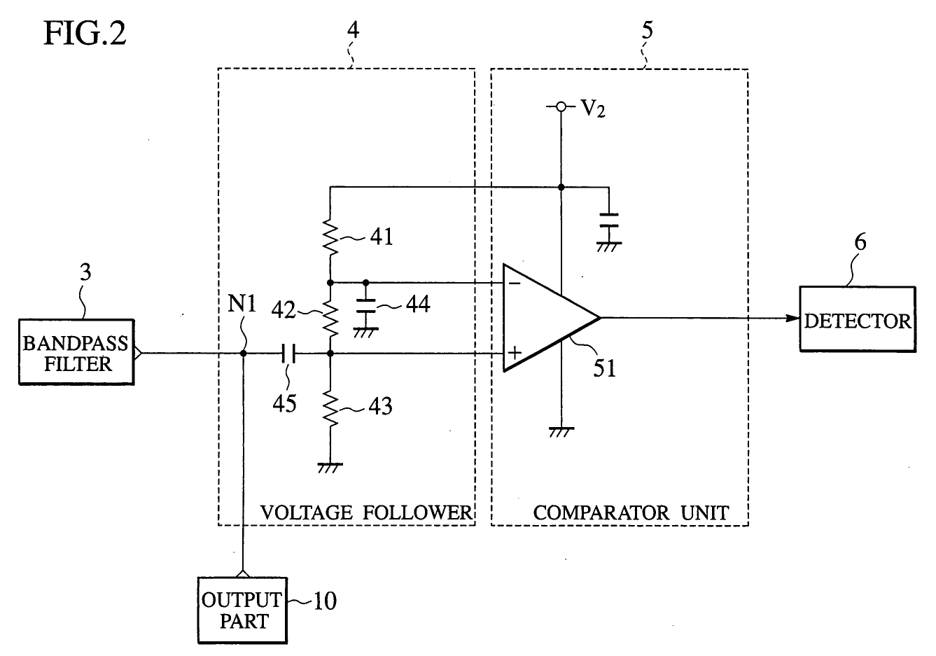

FIG. 2 is a view showing configurations of voltage follower 4 and comparator unit 5.

In FIG. 2, comparator unit 5 includes a comparator 51. Comparator 51 is driven by a power supply voltage V₂ at 5V. Voltage follower 4 includes resistors 41, 42, and 43 connected in series, and a capacitor 44. Resistor 41 includes one end connected to power source V₂ at 5 V, for example, and another end connected to an inverting input terminal (−) of comparator 51. Resistor 42 includes one end connected to the other end of resistor 41 and an inverting input terminal (−) of comparator 51, and another end connected to a non-inverting input terminal (+) of comparator 51. Resistor 43 includes one end connected to the other end of resistor 42 and the non-inverting input terminal (+) of comparator 51, and another end which is grounded. Capacitor 44 includes one end connected to the inverting input terminal (−) of comparator 51, and another end which is grounded. Capacitor 45 for cutting direct-current components or removing low-frequency components is connected between the non-inverting input terminal (+) of comparator 51 and junction N1.

The 12-V power supply voltage is divided by resistors 41, 42, and 43. The inverting input terminal (−) and the non-inverting input terminal (+) of comparator 51 are biased to given levels. The non-inverting input terminal (+) is biased by 12 V. The voltage at the inverting input terminal (−) is divided and set to the level obtained by dividing a difference in power supply voltages between 12 V and 5 V using resistors 41 and 42. Therefore, electric potential at the inverting input terminal (−) is biased lower by a certain value than that of the non-inverting input terminal (+). In this state, the reception signal inputted to PLC 2 is provided from bandpass filter 3 to the non-inverting input terminal (+) of comparator 51 through capacitor 45. The reception signal provided to the non-inverting input terminal (+) of comparator 51 is also provided to the inverting input terminal (−) of comparator 51 through resistor 42.

In this case, a specific frequency component of the reception signal is removed by capacitor 44. In other words, capacitor 44 functions as a low-pass filter for removing the specific frequency component (at a given value or more) from the reception signal. The frequency to be removed herein is determined in response to a capacitance value of capacitor 44. Capacitor 44 and resistor 42 collectively function as an integration circuit for smoothing the waveform of the reception signal. The reception signal is smoothed by capacitor 44 and formed into a smoothed signal. The signal which is set to a direct-current level (the smoothed signal) after removal of the specific frequency component from the reception signal by use of the filtering function of capacitor 44 is provided to the inverting input terminal (−) of comparator 51. Therefore, the inverting input terminal (−) of comparator 51 is constantly provided with the standard level for comparison which is obtained by adding the biased voltage of a fixed value to the voltage at the direct-current level (the smoothed signal) corresponding to the level of the reception signal. In this way, comparator 51 compares the reception signal provided to the non-inverting input terminal (+) with the standard level for comparison which is provided to the inverting input terminal (−) and varies in response to the level of the reception signal. That is, the reception signal is always compared with the standard level for comparison which maintains the constant electric potential difference from the reception signal. Here, it is also possible to use a filter for removing the specific frequency instead of capacitor 44 in order to remove the specific frequency component from the reception signal. Alternatively, it is possible to configure an integration circuit by use of a coil and a resistor instead of capacitor 44.

Even in a state where it has been conventionally impossible to compare the reception signal accurately with comparator unit 5 because the electric potential at junction N1 fluctuates immediately after a transmission signal is outputted from output part 10 due to discharge of electric charges accumulated in capacitor 45, the standard level for comparison following the variable electric potential at junction N1 is provided to the inverting input terminal (−) of comparator 51. In this way, even when the reception signal is inputted to voltage follower 4 immediately after the transmission signal is outputted from output part 10, the reception signal is compared with the accurate standard level for comparison which follows the voltage fluctuation at junction N1. Therefore, the reception signal is accurately amplified by comparator 51. Hence, it is possible to receive the communication signal immediately after transmission even when output part 10 is allowed to output a transmission signal at a CMOS logic level. In this way, it is possible to drastically shorten a time interval for receiving a signal after transmission compared with the related art, thus improving communication efficiency.

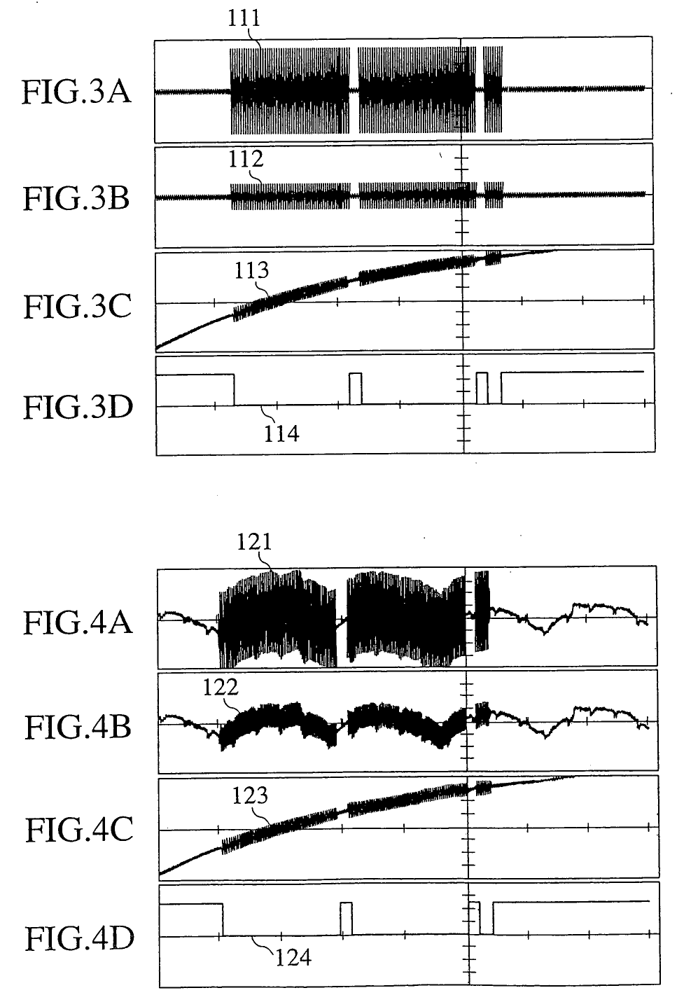

FIGS. 3A to 3D show waveforms 111 and 112 of the reception and transmission signals when an engine is stopped and waveforms 113 and 114 of the signals inputted to and outputted from comparator 51. FIGS. 4A to 4D show waveforms 121 and 122 of the reception and transmission signals when the engine is driven and waveforms 123 and 124 of the signals inputted to and outputted from comparator 51. In any case throughout FIGS. 3A to 3D and FIGS. 4A to 4D, it is obvious based on output signals 114 and 124 from comparator 51 that digital signals can be obtained by accurately amplifying and demodulating reception signals 112 and 122 even when the direct-current components of input signals 113 and 123 from comparator 51 are fluctuating.

Meanwhile, when low-frequency noises such as noises attributable to engine revolution or noises attributable to driving the ECU are superimposed on power line 11, these noises that bandpass filter 3 failed to remove will be inputted to comparator 51. However, the standard level for comparison which follows the electric potential fluctuation at junction N1 is provided to the inverting input terminal (−) of comparator 51. Accordingly, the reception signal is accurately compared with the standard level for comparison, and malfunction of comparator 51 is avoided. Therefore, even when the low-frequency noises are included in the reception signal, it is still possible to securely amplify and demodulate the reception signal.

The voltage follower includes a first voltage output part which is connected to a first input terminal of the comparator. The voltage follower includes a second voltage output part which is connected to a second input terminal of the comparator. The first and second voltage output parts are mutually connected by an impedance element. An input signal is inputted to one of the first and second voltage output parts. The input signal is smoothed by the impedance element and then inputted to the other voltage output part. The impedance element includes a smoothing element, an integrating element, or a capacitor for smoothing the input signal. The impedance element may include a voltage-dividing element or a resistor for dividing the voltage of the input signal.

The input signal is inputted to the comparator through one of the voltage output parts. The smoothed input signal is inputted to the comparator through the other voltage output part. In this case, the voltage of the smoothed input signal fluctuates in response to the input signal. Therefore, the comparator compares the input signal accurately with the smoothed input signal.

According to the characteristics of this invention, it is possible to generate the standard level for comparison which follows the voltage fluctuation at the input terminal of the voltage follower. In this way, even when the voltage at the input terminal fluctuates after transmission of the communication signal, it is possible to securely amplify and demodulate the communication signal by comparing the reception communication signal with the standard level for comparison. Therefore, the communication device can receive a subsequent communication signal immediately after transmission of the communication signal and drastically shorten a time interval for receiving a signal after transmission compared with the related art, and thereby improve communication efficiency.

Even when a low-frequency noise is included in the reception communication signal, the standard level for comparison is generated which follows the voltage fluctuation at the input terminal of the comparator unit. Accordingly, the reception communication signal is accurately compared with the standard level for comparison and a risk of malfunction is thereby eliminated. In this way, even when the low-frequency noise is included in the reception signal, it is possible to securely amplify and demodulate the reception signal.

The entire contents of Japanese Patent Application No. 2002-257573 are incorporated herein by reference.

What is claimed is:

1. A power line communication device for vehicle comprising:
a voltage follower configured to receive a reception communication signal with an input terminal, to generate a standard level for comparison which follows direct-current voltage fluctuation at the input terminal, and to output the standard level for comparison and the communication signal; and
a comparator unit configured to receive the standard level for comparison and the communication signal, to compare the standard level for comparison with the communication signal, and to amplify the communication signal which is superimposed and modulated on direct-current power on a power line,
wherein the power line communication device for vehicle is included in an electronic control unit controlling respective functions of the vehicle, connected to the power line supplying the direct-current power to the vehicle, and configured to receive the communication signal superimposed on the direct-current power on the power line, to separate and extract the communication signal superimposed on a direct-current component, to superimpose and transmit the generated communication signal on the direct-current power on the power line, and to transmit and receive the communication signal between the electronic control units.

2. The power line communication device for vehicle according to claim 1,
wherein the comparator unit comprises a comparator including a first input terminal and a second input terminal,
the voltage follower comprises:
voltage-dividing resistors connected in series between a high-voltage power source and a low-voltage power source; and
a capacitor configured to remove a given frequency component from the reception communication signal and to obtain a direct-current component of the communication signal, and
a first junction of the voltage-dividing resistors is connected to the first input terminal, a second junction of the voltage-dividing resistors is connected to the second input terminal, and the capacitor is connected between the first input terminal and the low-voltage power source.

3. The power line communication device for vehicle according to claim 1,
wherein the comparator unit comprises the comparator including the first input terminal and the second input terminal,
the voltage follower comprises:
the voltage-dividing resistors connected in series between the high-voltage power source and the low-voltage power source; and
a filter configured to remove a given frequency component from the reception communication signal and to obtain a direct-current component of the communication signal, and
the first junction of the voltage-dividing resistors is connected to the first input terminal, the second junction of the voltage-dividing resistors is connected to the second input terminal, and the filter is connected to the first input terminal.
